(19) United States
(12) Patent Application Publication
(10) Pub. No.: US 2012/0277352 A1
(43) Pub. Date: Nov. 1, 2012

(54) LIGHT STABILIZED COPOLYETHERESTER COMPOSITION

(75) Inventors: Yong Ni, Shanghai (CN); Edward Maxwell De Brant Smith, Wilmington, DE (US)

(73) Assignee: E.I. DU PONT DE NEMOURS AND COMPANY, Wilmington, DE (US)

(21) Appl. No.: 13/280,236

(22) Filed: Oct. 24, 2011

(30) Foreign Application Priority Data
Oct. 29, 2010 (CN) 201010538258.9

(51) Int. Cl. C08L 67/00; C08K 9/04; C08K 3/22; C08K 5/3475; C08K 9/02; C08K 9/06; B82Y 30/00

(52) U.S. Cl. 524/91; 977/773

(57) ABSTRACT

Disclosed herein is a light stabilized copolyetherester composition that is substantially free of carbon black, and wherein the copolyetherester composition comprises, based on the total weight of the copolyetherester composition, (a) about 90-98.8 wt. % of at least one copolyetherester, (b) about 0.1-2 wt. % of at least one organic UV absorber selected from benzotriazole based UV absorbers and benzophenone based UV absorber, (c) about 0.1-2 wt. % of at least one hindered amine light stabilizer, and (d) about 1-6 wt. % of at least one mineral filler comprising mineral particles selected from the group consisting of titanium dioxide particles, cerium oxide particles, zinc oxide particles, and mixtures of two or more thereof.

### CROSS-REFERENCE TO RELATED APPLICATIONS

This application claims priority from China National Patent Application No. 201010538258.9, filed on Oct. 29, 2010, which is incorporated herein by reference in its entirety.

### FIELD OF DISCLOSURE

This invention relates to an ultraviolet light stabilized copolyetherester composition.

### BACKGROUND OF THE INVENTION

Due to their excellent tear strength, tensile strength, flex life, abrasion resistance, and suitability for a broad range of end-use temperatures, thermoplastic copolyetherester elastomers are used in numerous applications. However, copolyetheresters are known to be particularly sensitive to ultraviolet (UV) radiation (see for example, F. Gugumus in: R. Gächter, H. Müller (ed).; Plastics Additives Handbook, 3^{rd} Ed., Hanser Publishers, Munich 1990, p. 170). Many outdoor articles made of copolyetheresters are exposed to UV radiation during their normal use. Organic UV light stabilizers are often added to such copolyetherester compositions to improve their UV resistance and thereby increasing the useful life of the articles made therefrom. Upon prolonged exposure to UV radiation, however, typical organic UV light stabilizers that have been used in copolyetherester compositions can degrade, leading to a loss of physical properties of the copolyetherester compositions and a diminished surface appearance of products made of the copolyetherester compositions. It is also known to add inorganic UV light stabilizers, such as carbon black, into copolyetherester compositions to improve their UV resistance. However, an inevitable result of the addition of carbon black is that the copolyetherester compositions will have a black or near-black color. Therefore, carbon black is not suitable as a UV stabilizer in those applications where the copolyetherester's natural color or other non-black color is required.

Attempts have also been made to improve the UV resistance of copolyetherester compositions that are free of carbon black. For example, International Patent Application publication WO00/27914 discloses a thin packaging film made of a thermoplastic material having UV resistance. The thermoplastic material contains at least one organic UV-blocking compound and at least one inorganic UV-blocking compound, wherein the inorganic UV-blocking compound may be micronized zinc oxide or micronized titanium dioxide. Also, U.S. Pat. No. 7,754,825 discloses a UV stabilized copolyetherester composition that includes about 0.1-4 wt. % of at least one nanoparticular mineral and about 0.1-4 wt. % of at least one organic UV stabilizer, such as an hindered amine light stabilizer.

There is, however, still a need to further improve the UV resistance of non-black copolyetherester compositions to meet the requirements of outdoor applications.

### SUMMARY OF THE INVENTION

The present invention is directed to a light stabilized copolyetherester composition, which is substantially free of carbon black and possesses good UV resistance, such as low yellowness index change (ΔYI) after UV aging and high retention rate of nominal strain at break after UV aging. Moreover, as the copolyetherester composition is substantially free of carbon black, it is useful in forming articles having natural or other non-black light colors.

Disclosed herein is a light stabilized copolyetherester composition that is substantially free of carbon black, wherein the copolyetherester composition comprises, based on the total weight of the copolyetherester composition, (a) about 90-98.8 wt. % of at least one copolyetherester, (b) about 0.1-2 wt. % of at least one organic UV absorber selected from the group consisting of benzotriazole based UV absorbers and benzophenone based UV absorber, (c) about 0.1-2 wt. % of at least one hindered amine light stabilizer, and (d) about 1-6 wt. % of at least one mineral filler comprising mineral particles selected from the group consisting of titanium dioxide particles, cerium oxide particles, zinc oxide particles, and mixtures of two or more thereof.

In one embodiment, the at least one copolyetherester comprises a multiplicity of recurring long-chain ester units and recurring short-chain ester units joined head-to-tail through ester linkages, the long-chain ester units being represented by formula (I):

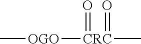

and the short-chain ester units being represented by formula (II):

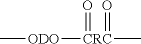

wherein,
G is a divalent radical remaining after the removal of terminal hydroxyl groups from a poly(alkylene oxide) glycol having a number average molecular weight of about 400-6000, or about 600-3000;
R is a divalent radical remaining after the removal of carboxyl groups from a dicarboxylic acid having a number average molecular weight of about 300 or lower, or about 10-300, or about 30-200, or about 50-100; and
D is a divalent radical remaining after the removal of hydroxyl groups from a glycol having a molecular weight of about 250 or lower, or about 10-250, or about 20-150, or about 50-100, and

wherein,
based on the total weight of the at least one copolyetherester, the content levels of the recurring long-chain ester units and the recurring short-chain ester units are about 1-85 wt. % and about 15-99 wt. %, respectively; or about 5-80 wt. % and about 20-95 wt. %, respectively; or about 10-75 wt. % and about 25-90 wt. %, respectively; or about 40-75 wt. % and about 25-60 wt. %, respectively.

In a further embodiment, the mineral particles have a weight average particle diameter of about 10-200 nm, or about 30-175 nm, or about 50-150 nm.

In a yet further embodiment, the mineral particles are titanium dioxide particles.

In a yet further embodiment, the mineral particles are coated with organic coatings or inorganic coatings. The organic coatings may comprise a material selected from the group consisting of carboxylic acids, polyols, alkanolamines, silicon compounds, and mixtures of two or more thereof. The inorganic coatings may comprise a material selected from the group consisting of oxides and hydrous oxides of silicon, aluminum, zirconium, phosphorous, zinc, and rare earth elements, and mixtures of two or more thereof. Or, the inorganic coatings may comprise alumina.

In a yet further embodiment, the at least one mineral filler comprises titanium dioxide particles having a weight average particle diameter of about 10-200 nm, or about 30-175 nm, or about 50-150 nm. The titanium dioxide particles may be coated with alumina.

In a yet further embodiment, the at least one organic UV absorber is selected from benzotriazole based UV absorbers.

In a yet further embodiment, based on the total weight of the copolyetherester composition, the copolyetherester composition comprises about 90-98.8 wt. % of the at least one copolyetherester, about 0.1-2 wt. % of the at least one organic UV absorber, about 0.1-2 wt. % of the at least one hindered amine light stabilizer, and about 1-6 wt. % of the mineral filler.

In a yet further embodiment, based on the total weight of the copolyetherester composition, the copolyetherester composition comprises about 92-98.8 wt. % of the at least one copolyetherester, about 0.1-1 wt. % of the at least one organic UV absorber, about 0.1-1 wt. % of the at least one hindered amine light stabilizer, and about 1-6 wt. % of the mineral filler.

In a yet further embodiment, based on the total weight of the copolyetherester composition, the copolyetherester composition comprises about 92-98.6 wt. % of the at least one copolyetherester, about 0.1-0.6 wt. % of the at least one organic UV absorber, about 0.1-0.6 wt. % of the at least one hindered amine light stabilizer, and about 1-6 wt. % of the mineral filler.

In a yet further embodiment, based on the total weight of the copolyetherester composition, the copolyetherester composition comprises about 92-97.8 wt. % of the at least one copolyetherester, about 0.1-1 wt. % of the at least one organic UV absorber, about 0.1-1 wt. % of the at least one hindered amine light stabilizer, and about 2-6 wt. % of the mineral filler.

In a yet further embodiment, based on the total weight of the copolyetherester composition, the copolyetherester composition comprises about 92-95.8 wt. % of the at least one copolyetherester, about 0.1-1 wt. % of the at least one organic UV absorber, about 0.1-1 wt. % of the at least one hindered amine light stabilizer, and about 4-6 wt. % of the mineral filler.

In a yet further embodiment, based on the total weight of the copolyetherester composition, the copolyetherester composition comprises about 92.8-95.6 wt. % of the at least one copolyetherester, about 0.2-0.6 wt. % of the at least one organic UV absorber, about 0.2-0.6 wt. % of the at least one hindered amine light stabilizer, and about 4-6 wt. % of the mineral filler.

In a yet further embodiment, the copolyetherester composition has a yellowness index change (ΔYI) of less than about 2.3, or less than about 2, or less than about 1.5 after 1500-hour aging.

Further disclosed herein is an article formed from the light stabilized copolyetherester composition described above. In one embodiment, the article is a molded article. In a further embodiment, the article is an insulating layer or jacket for wires and cables.

### DETAILED DESCRIPTION OF THE INVENTION

The invention disclosed herein provides a UV stabilized copolyetherester composition that is substantially free of carbon black, wherein the composition comprises, based on the total weight of the composition,
(a) about 90-98.8 wt. % of at least one copolyetherester,
(b) about 0.1-2 wt. % of at least one organic UV absorber (UVA) selected from the group consisting of benzotriazole based UVAs, benzophenone based UVAs, and mixtures thereof,
(c) about 0.1-2 wt. % of at least one hindered amine light stabilizer (HALS); and
(d) about 1-6 wt. % of at least one mineral filler comprising mineral particles selected from titanium dioxide particles, cerium oxide particles, zinc oxide particles, and mixtures of two or more thereof.

The copolyetheresters suitable for use in the compositions disclosed herein may be copolymers having a multiplicity of recurring long-chain ester units and recurring short-chain ester units joined head-to-tail through ester linkages, the long-chain ester units being represented by formula (I):

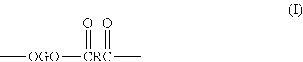

and the short-chain ester units being represented by formula (II):

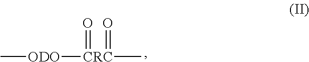

wherein,

G is a divalent radical remaining after the removal of terminal hydroxyl groups from poly(alkylene oxide) glycols having a number average molecular weight of about 400-6000;

R is a divalent radical remaining after the removal of carboxyl groups from a dicarboxylic acid having a number average molecular weight of about 300 or less;

D is a divalent radical remaining after the removal of hydroxyl groups from a glycol having a number average molecular weight of about 250 or less, and

wherein,

the at least one copolyetherester contains about 1-85 wt. % of the recurring long-chain ester units and about 15-99 wt. % of the recurring short-chain ester units.

In one embodiment, the copolyetherester used in the composition disclosed herein contains about 5-80 wt. % of the recurring long-chain ester units and about 20-95 wt. % of the recurring short-chain ester units.

In a further embodiment, the copolyetherester used in the composition disclosed herein contains about 10-75 wt. % of the recurring long-chain ester units and about 25-90 wt. % of the recurring short-chain ester units.

In a yet further embodiment, the copolyetherester used in the composition disclosed herein contains about 40-75 wt. % of the recurring long-chain ester units and about 25-60 wt. % of the recurring short-chain ester units.

As used herein, the term “long-chain ester units” refers to reaction products of a long-chain glycol with a dicarboxylic acid. Suitable long-chain glycols are poly(alkylene oxide) glycols having terminal hydroxyl groups and a number average molecular weight of about 400-6000, or about 600-3000, which include, without limitation, poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. The long-chain glycols used herein may also be combinations of two or more of the above glycols.

As used herein, the term “short-chain ester units” refers to reaction products of a low molecular weight glycol or an ester-forming derivative thereof with a dicarboxylic acid. Suitable low molecular weight glycols are those having a number average molecular weight of about 250 or lower, or about 10-250, or about 20-150, or about 50-100, which include, without limitation, aliphatic dihydroxy compounds, alicyclic dihydroxy compounds, and aromatic dihydroxy compounds (including bisphenols). In one embodiment, the low molecular weight glycol used herein is a dihydroxy compound having 2-15 carbon atoms, such as ethylene glycol; propylene glycol; isobutylene glycol; 1,4-tetramethylene glycol; pentamethylene glycol; 2,2-dimethyltrimethylene glycol; hexamethylene glycol; decamethylene glycol; dihydroxycyclohexane; cyclohexanedimethanol; resorcinol; hydroquinone; 1,5-dihydroxynaphthalene; or the like. In a further embodiment, the low molecular weight glycol used herein is a dihydroxy compound having 2-8 carbon atoms. In a yet further embodiment, the low molecular weight glycol used herein is 1,4-tetramethylene glycol. Bisphenols that are useful herein include, without limitation, bis(p-hydroxy)diphenyl, bis(p-hydroxyphenyl)methane, bis(p-hydroxyphenyl)propane, and mixtures of two or more thereof.

The ester-forming derivatives of low molecular weight glycols useful herein include those derived from the low molecular weight glycols described above, such as ester-forming derivatives of ethylene glycol (e.g., ethylene oxide or ethylene carbonate) or ester-forming derivatives of resorcinol (e.g., resorcinol diacetate). As used herein, the number average molecular weight limitations pertain to the low molecular weight glycols only. Therefore, a compound that is an ester-forming derivative of a glycol and has a number average molecular weight more than 250 can also be used herein, provided that the corresponding glycol has a number average molecular weight of about 250 or lower.

The “dicarboxylic acids” useful for reaction with the above described long-chain glycols or low molecular weight glycols are those low molecular weight (i.e., number average molecular weight of about 300 or lower, or about 10-300, or about 30-200, or about 50-100) aliphatic, alicyclic, or aromatic dicarboxylic acids.

The term “aliphatic dicarboxylic acids” used herein refers to those carboxylic acids having two carboxyl groups each attached to a saturated carbon atom. If the carbon atom to which the carboxyl group is attached to is saturated and is in a ring, the acid is referred to as an “alicyclic dicarboxylic acid”. The term “aromatic dicarboxylic acids” used herein refers to those dicarboxylic acids having two carboxyl groups each attached to a carbon atom in an aromatic ring structure. It is not necessary that both functional carboxyl groups in the aromatic dicarboxylic acid be attached to the same aromatic ring. Where more than one ring is present, they can be joined by aliphatic or aromatic divalent radicals or divalent radical such as —O— or —SO₂—.

The aliphatic or alicyclic dicarboxylic acids useful herein include, without limitation, sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethyl suberic acid; cyclopentane dicarboxylic acid; decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl) carboxylic acid; 3,4-furan dicarboxylic acid; and mixtures of two or more thereof. In one embodiment, the dicarboxylic acids used herein are selected from cyclohexane dicarboxylic acids, adipic acids, and mixtures thereof.

The aromatic dicarboxylic acids useful herein include, without limitation, phthalic acids; terephthalic acids; isophthalic acids; dibenzoic acids; dicarboxylic compounds with two benzene nuclei (such as bis(p-carboxyphenyl)methane; p-oxy-1,5-naphthalene dicarboxylic acid; 2,6-naphthalene dicarboxylic acid; 2,7-naphthalene dicarboxylic acid; or 4,4′-sulfonyl dibenzoic acid); and C₁-C₁₂ alkyl and ring substitution derivatives of the aromatic dicarboxylic acids described above (such as halo, alkoxy, and aryl derivatives thereof). The aromatic dicarboxylic acids useful herein may also be, for example, hydroxyl acids such as p-(β-hydroxyethoxy)benzoic acid.

In one embodiment of the compositions disclosed herein, the dicarboxylic acids used to form the copolyetheresters component may be selected from aromatic dicarboxylic acids. In a further embodiment, the dicarboxylic acids may be selected from aromatic dicarboxylic acids having about 8-16 carbon atoms. In a yet further embodiment, the dicarboxylic acids may be terephthalic acid alone or a mixture of terephthalic acid with phthalic acid and/or isophthalic acid.

In addition, the dicarboxylic acids useful herein may also include functional equivalents of dicarboxylic acids. In forming the copolyetheresters, the functional equivalents of dicarboxylic acids reacts with the above described long-chain and low molecular weight glycols substantially the same way as dicarboxylic acids. Useful functional equivalents of dicarboxylic acids include ester and ester-forming derivatives of dicarboxylic acids, such as acid halides and anhydrides. As used herein, the number average molecular weight limitations pertain only to the corresponding dicarboxylic acids, not the functional equivalents thereof (such as the ester or ester-forming derivatives thereof). Therefore, a compound that is a functional equivalent of a dicarboxylic acid and has a number average molecular weight more than 300 can also be used herein, provided that the corresponding dicarboxylic acid has a number average molecular weight of about 300 or lower. Moreover, the dicarboxylic acids may also contain any substituent groups or combinations thereof that do not substantially interfere with the copolyetherester formation and the use of the copolyetherester in the compositions disclosed herein.

The long-chain glycols used in forming the copolyetherester component of the composition disclosed herein may also be mixtures of two or more long-chain glycols. Similarly, the low molecular weight glycols and dicarboxylic acids used in forming the copolyetherester component may also be mixtures of two or more low molecular weight glycols and mixtures of two or more dicarboxylic acids, respectively. In a preferred embodiment, at least about 70 mol % of the groups represented by R in Formulas (I) and (II) above are 1,4-phenolene radicals, and at least 70 mol % of the groups represented by D in Formula (II) above are 1,4-butylene radicals. When two or more dicarboxylic acids are used in forming the copolyetherester, it is preferred to use a mixture of terephthalic acid and isophthalic acid, while when two or more low molecular weight glycols are used, it is preferred to use a mixture of 1,4-tetramethylene glycol and hexamethylene glycol.

The at least one copolyetherester that is a component of the copolyetherester composition disclosed herein may also be a blend of two or more copolyetheresters. It is not required that the copolyetheresters comprised in the blend, individually meet the weight percentages requirements disclosed hereinbefore for the short-chain and long-chain ester units. However, the blend of two or more copolyetheresters must conform to the values described hereinbefore for the copolyetheresters on a weighted average basis. For example, in a blend that contains equal amounts of two copolyetheresters, one copolyetherester may contain about 10 wt. % of the short-chain ester units and the other copolyetherester may contain about 80 wt. % of the short-chain ester units for a weighted average of about 45 wt. % of the short-chain ester units in the blend.

In one embodiment, the at least one copolyetherester component of the copolyetherester composition disclosed herein is obtained by the copolymerization of a dicarboxylic acid ester selected from esters of terephthalic acid, esters of isophthalic acid, and mixtures thereof, with a lower molecular weight glycol that is 1,4-tetramethylene glycol and a long-chain glycol that is poly(tetramethylene ether) glycol or ethylene oxide-capped polypropylene oxide glycol. In a further embodiment, the at least one copolyetherester is obtained by the copolymerization of an ester of terephthalic acid (e.g., dimethylterephthalate) with 1,4-tetramethylene glycol and poly(tetramethylene ether) glycol.

The copolyetheresters useful in the compositions disclosed herein may be made by any suitable methods known to those skilled in the art, such as by using a conventional ester interchange reaction.

In one embodiment, the method involves heating an dicarboxylic acid ester (e.g., dimethylterephthalate) with a poly(alkylene oxide) glycol and a molar excess of a low molecular weight glycol (e.g., 1,4-tetramethylene glycol) in the presence of a catalyst, followed by distilling off methanol formed by the interchange reaction and continuing the heat until methanol evolution is complete. Depending on the selection of temperatures and catalyst types and the amount of the low molecular weight glycols used, the polymerization may be completed within a few minutes to a few hours and results in formation of a low molecular weight pre-polymer. Such pre-polymers can also be prepared by a number of alternate esterification or ester interchange processes, for example, by reacting a long-chain glycol with a short-chain ester homopolymer or copolymer in the presence of catalyst until randomization occurs. The short-chain ester homopolymer or copolymer can be prepared by the ester interchange either between a dimethyl ester (e.g., dimethylterephthalate) and a low molecular weight glycol (e.g, 1,4-tetramethylene glycol) as described above, or between a free acid (e.g., terephthalic acid) and a glycol acetate (e.g., 1,4-butanediol diacetate). Alternatively, the short-chain ester homopolymer or copolymer can be prepared by direct esterification from appropriate acids (e.g., terephthalic acid), anhydrides (e.g., phthalic anhydride), or acid chlorides (e.g., terephthaloyl chloride) with glycols (e.g., 1,4-tetramethylene glycol). Or, the short-chain ester homopolymer or copolymer may be prepared by any other suitable processes, such as the reaction of dicarboxylic acids with cyclic ethers or carbonates.

Further, the pre-polymers obtained as described above can be converted to high molecular weight copolyetheresters by the distillation of the excess low molecular weight glycols. Such process is known as “polycondensation”. Additional ester interchange occurs during the polycondensation process to increase the molecular weight and to randomize the arrangement of the copolyetherester units. In general, to obtained the best results, the polycondensation may be run at a pressure of less than about 1 mm and a temperature of about 240-260° C., in the presence of antioxidants (such as 1,6-bis-(3,5-di-tert-butyl-4-hydroxyphenol)propionamido]-hexane or 1,3,5-trimethyl-2,4,6-tris[3,5-di-tert-butyl-4-hydroxybenzyl]benzene), and for less than about 2 hours. In order to avoid excessive holding time at high temperatures with possible irreversible thermal degradation, it is advantageous to employ a catalyst for ester interchange reactions. A wide variety of catalysts can be used herein, which include, without limitation, organic titanates (such as tetrabutyl titanate alone or in combination with magnesium or calcium acetates), complex titanates (such as those derived from alkali or alkaline earth metal alkoxides and titanate esters), inorganic titanates (such as lanthanum titanate), calcium acetate/antimony trioxide mixtures, lithium and magnesium alkoxides, stannous catalysts, and mixtures of two or more thereof.

The copolyetheresters useful in the compositions disclosed herein can also be obtained commercially from E.I. du Pont de Nemours and Company, U.S.A. (hereafter “DuPont”) under the tradename of Hytrel®.

Based on the total weight of the copolyetherester composition disclosed herein, the at least one copolyetherester may be present at a level of about 90-98.8 wt. %, or about 92-98.8 wt. %, or about 92-97.8 wt. %, or about 92-95.8 wt. %, or about 92.8-98.6 wt. %, or about 92.8-95.6 wt. %.

The at least one organic UVA comprised in the copolyetherester composition disclosed herein may be selected from benzotriazole based UVAs, benzophenone based UVAs, and mixtures thereof.

The benzotriazole based UVAs useful herein are benzotriazole derivative compounds having benzotriazole backbones. Exemplary benzotriazole based UVAs include, without limitation,
2-(2′-hydroxy-5′-methylphenyl)benzotriazole;
2-(2′-hydroxy-3′,5′-di-tert-butylphenyl)benzotriazole;
2-(2′-hydroxy-3′-tert-butyl-5′-methylphenyl)benzotriazole;
2-(2′-hydroxy-3′,5;-di-tert-butylphenyl)-5-chloro benzotriazole;
2-(2′-hydroxy-3′-(3″,4″,5″,6″-tetrahydro phthalimidomethyl)-5′-methylphenyl)benzotriazole;
2,2-methylenebis (4-(1,1,3,3-tetramethylbutyl)-6-(2H-benzotriazole-2-yl)phenol);
2-(2′-hydroxy-3′-tert-butyl-5′-methylphenyl)-5-chlorobenzotriazole;
2-(2H-benzotriazole-2-yl)-6-(n- and iso-dodecyl)-4-methylphenol (TINUVIN™171, product of BASF, Germany);
a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate (TINUVIN™109, product of BASF, Germany);
2-(2′-Hydroxy-3′,5′-di-tert-butylphenyl)-5-chlorobenzortriazole (TINUVIN™327, product of BASF, Germany);
2-(5-chloro-2H-benzotriazole-2-yl)-6-(1,1-dimethylethyl)-4-methyl (TINUVIN™326, product of BASF, Germany);

and mixtures of two or more thereof.

The benzophenone based UVAs useful herein are benzophenone derivative compounds having benzophenone backbones. Exemplary benzophenone based UVAs include, without limitation,
2,4-dihydroxybenzophenone;
2,2′-di-hydroxy-4-methoxybenzophenone;
2-hydroxy-4-methoxy-5-sulfobenzophenone;
bis(2-methoxy-4-hydroxy-5-benzoylphenylmethane); and

mixtures of two or more thereof.

The at least one organic UVA may be present in the copolyetherester composition disclosed herein at a level of about 0.1-2 wt. %, or about 0.1-1 wt. %, or about 0.2-0.6 wt. %, based on the total weight of the copolyetherester composition.

In one embodiment, the copolyetherester composition disclosed herein comprises about 0.1-2 wt. %, or about 0.1-1 wt. %, or about 0.2-0.6 wt. % of at least one benzotriazole based UVA.

The at least one HALS comprised in the copolyetherester composition disclosed herein may be one or a combination of two or more HALS.

Suitable HALS may be selected from compounds having the following general formulas:

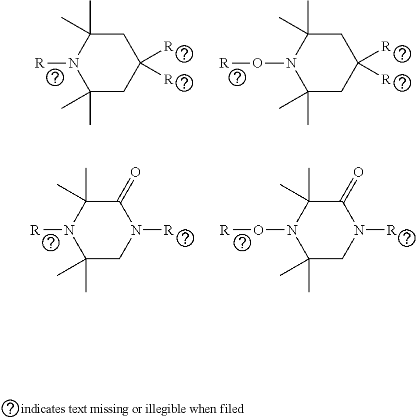

In these formulas, R₁ up to and including R₅ are independent substituents. Examples of suitable substituents include, without limitation, hydrogen, ether groups, ester groups, amine groups, amide groups, alkyl groups, alkenyl groups, alkynyl groups, aralkyl groups, cycloalkyl groups, and aryl groups, in which the substituents in turn may further contain functional groups, examples of suitable functional groups including, without limitation, alcohols, ketones, anhydrides, imines, siloxanes, ethers, carboxyl groups, aldehydes, esters, amides, imides, amines, nitriles, ethers, urethanes, and combinations of two or more thereof.

Suitable HALS may also include polymers or oligomers comprising the HALS compounds described above.

Suitable HALS are also commercially available, and include, without limitation,
Good-Rite™ 3034, 3150, and 3159 hindered amine light stabilizers (available from BFGoodrich Corporation, U.S.A.);
Tinuvin™ 770, 622LD, 123, 765, 144, and XT850 hindered amine light stabilizers, Chimassorb™ 119FL and 944 hindered amine light stabilizers, and Uvinul™ 4050H hindered amine light stabilizer (available from BASF, Germany);
Hostavin™ N20 and N30 hindered amine light stabilizers and Sanduvor™ PR31 hindered amine light stabilizer (available from Clariant, Switzerland);
Cyasorb™ UV3346, UV-500, UV-516, and UV-3529 hindered amine light stabilizers (available from Cytec Industries, U.S.A.);
ADK STAB LA63 and ADK STAB LA68 hindered amine light stabilizers (available from Adeka Corporation, Japan); and
Uvasil™ 299 hindered amine light stabilizer (available from Chemtura Corporation, U.S.A.).

The at least one HALS may be present in the copolyetherester composition disclosed herein at a level of about 0.1-2 wt. %, or about 0.1-1 wt. %, or about 0.2-0.6 wt. %, based on the total weight of the copolyetherester composition.

The mineral fillers useful in the copolyetherester compositions disclosed herein comprise mineral particles selected from titanium oxide particles, cerium oxide particles, zinc oxide particles, and mixtures of two or more thereof. In one embodiment, the mineral particles comprised in the mineral fillers are nanosized mineral particles. In a further embodiment, the mineral particles are nanosized mineral particles having a weight average particle diameter of about 10-200 nm, or about 30-175 nm, or about 50-150 nm. The mineral fillers may also comprise other additional additives to improve the durability characteristics or other properties of the fillers. For example, such additional additives may include, without limitation, hydrous oxides (such as silica, alumina, tin oxide, lead oxide, chromium oxides) and the like.

In one embodiment, the mineral fillers used herein comprise titanium dioxide particles.

In a further embodiment, the mineral fillers used herein comprise nanosized titanium dioxide particles having a weight average particle diameter of about 10-200 nm, or about 30-175 nm, or about 50-150 nm.

In accordance with the present disclosure, the mineral particles comprised in the mineral fillers may also be coated with organic and/or inorganic coatings.

Suitable inorganic coatings may be formed of inorganic materials selected from, without limitation, metal oxides and hydrous oxides, such as oxides and hydrous oxides of silicon, aluminum, zirconium, phosphorous, zinc, rare earth elements, and mixtures of two or more thereof. In one embodiment, the inorganic coating used herein may be formed of alumina.

Suitable organic coatings may by formed of organic materials selected from, without limitation, carboxylic acids, polyols, alkanolamines, silicon compounds, and mixtures of two or more thereof. Suitable carboxylic acids used in forming the organic coatings include, without limitation, adipic acid, terephthalic acid, lauric acid, myristic acid, palmitic acid, stearic acid, polyhydroxystearic acid, oleic acid, salicylic acid, malic acid, maleic acid, and mixtures of two or more thereof. As used herein, the “carboxylic acids” used in forming the organic coatings may also include esters of the carboxylic acids mentioned immediately above, salts of the carboxylic acids immediately mentioned above, and mixtures thereof. Suitable polyols include, without limitation, ethylene glycol, propylene glycol, butanediol, hexanediol, and mixtures of two or more thereof. Suitable alkanolamines include, without limitation, ethanolamine, ethylene glycol amine, propanol amine, propylene glycol amine, and mixtures of two or more thereof. Suitable silicon compounds include, without limitation, silicates, silanes (e.g., organoalkoxysilanes, aminosilanes, epoxysilanes, and mercaptosilanes), siloxanes (e.g., polyhydroxysiloxanes), and mixtures of two or more thereof. In one embodiment, the silanes used in forming the organic coatings have a formula of RₓSi(R′)₄₋ₓ wherein R is a nonhydrolyzable aliphatic, cycloaliphatic, or aromatic group having about 1-20 carbon atoms, R′ is one or more hydrolyzable groups (e.g., one or more alkoxy, halogen, acetoxy, and/or hydroxy groups), and X is 1, 2 or 3. In a further embodiment, the silanes used in forming the organic coatings are selected from hexyltrimethoxysilane, octyltriethoxysilane, nonyltriethoxysilane, decyltriethoxysilane, dodecyltriethoxysilane, tridecyltriethoxysilane, tetradecyltriethoxysilane, pentadecyltriethoxysilane, hexadecyltriethoxysilane, heptadecyltriethoxysilane, octadecyltriethoxysilane, N-(2-aminoethyl) 3-aminopropylmethyldimethoxysilane, N-(2-aminoethyl) 3-aminopropyltrimethoxysilane, 3-aminopropyltriethoxysilane, 3-glycidoxypropyltrimethoxysilane, 3-glycidoxypropylmethyldimethoxysilane, 3-mercaptopropyltrimethoxysilane, and combinations of two or more thereof.

In one embodiment, the mineral particles (e.g., titanium dioxide particles or nanosized titanium dioxide particles) comprised in the mineral fillers are coated with an inorganic coating (e.g., alumina). In addition, the mineral particles that are coated with inorganic coatings may be further coated with other coatings (e.g., an organic coating).

When present, the organic coatings may comprise about 0.1-10 wt. % or about 0.5-7 wt. %, or about 0.5-5 wt. % of the total weight of the mineral fillers, while the inorganic coatings may comprise about 0.25-50 wt. %, or about 1-25 wt. %, or about 2-20 wt. % of the total weight of the mineral fillers.

The mineral particles (e.g., titanium dioxide particles) comprised in the mineral fillers may be prepared by any suitable method known to those skilled in the art. Additionally, phosphoric acid, metal phosphates, metal halides, metal carbonates, metal sulfates, and combinations of two or more thereof may be used to control the crystallinity, degree of amorphousness, or millability of the particles. Suitable metals for the foregoing include sodium, potassium, aluminum, tin, or zinc.

Based on the total weight of the copolyetherester composition disclosed herein, the at least one mineral filler may be present at a level of about 1-6 wt. %, or about 2-6 wt. %, or about 4-6 wt. %.

The copolyetherester composition disclosed herein may further comprise other additives, such as colorants, antioxidants, heat stabilizers, lubricants, reinforcing agents, viscosity modifiers, nucleating agents, plasticizers, mold release agents, flame retardants, scratch and mar modifiers, impact modifiers, and combinations of two or more thereof.

However, the copolyetherester composition disclosed herein is substantially free of carbon black. The term “substantially free of carbon black” used herein refers to a content level of carbon black being less than about 0.1 wt. %, based on the total weight of the copolyetherester composition.

In one embodiment, based on the total weight of the copolyetherester composition disclosed herein, the at least one copolyetherester, the at least one organic UVA, the at least one HALS, and the at least one mineral filler are present in amounts of,
about 90-98.8 wt. %, about 0.1-2 wt. %, about 0.1-2 wt. %, and about 1-6 wt. %, respectively; or
about 92-98.8 wt %, about 0.1-1 wt,%, about 0.1-1 wt,%, and about 1-6 wt, %, respectively; or
about 92.8-98.6 wt. %, about 0.2-0.6 wt. %, about 0.2-0.6 wt. %, and about 1-6 wt. %, respectively; or
about 92-97.8 wt. %, about 0.1-1 wt. %, about 0.1-1 wt. %, and about 2-6 wt. %, respectively; or
about 92-95.8 wt. %, about 0.1-1 wt. %, about 0.1-1 wt. %, and about 4-6 wt. %, respectively; or
about 92.8-95.6 wt. %, about 0.2-0.6 wt. %, about 0.2-0.6 wt. %, and about 4-6 wt. %, respectively.

The copolyetherester compositions disclosed herein are melt-mixed blends, wherein all of the polymeric components are well-dispersed within each other and all of the non-polymeric ingredients are homogeneously dispersed in and bound by the polymer matrix, such that the blend forms a unified whole. Any melt-mixing method may be used to combine the polymeric components and non-polymeric ingredients of the composition disclosed herein.

In one embodiment, during the melt mixing process, the mineral fillers are added in the form of masterbatches, wherein the masterbatches are prepared by dispersing high concentration of mineral particles in a polymer matrix such as a copolyetherester.

In a further embodiment, the melt-mixing process involves, adding the polymeric components and the non-polymeric ingredients all at once or in a stepwise fashion into a melt mixer (such as, for example, a single or twin-screw extruder; a blender; a kneader; or a Banbury mixer) and then melt-mixing the blend. When adding the polymeric components and the non-polymeric ingredients in a stepwise fashion, part of the polymeric components and/or part of the non-polymeric ingredients are first added and melt-mixed, with the remaining polymeric components and the remaining non-polymeric ingredients being subsequently added and further melt-mixed until a well-mixed composition is obtained.

As demonstrated by the examples below, in the presence of both organic UVA (i.e., benzotriazole and/or benzophenone based UVA) and HALS, the addition of mineral fillers (e.g., titanium dioxide particles) improves the retention rate of nominal strain at break (after aging) of the copolyetherester composition. Moreover, it has been demonstrated that with the addition of such a three-component UV stabilizing package (i.e., organic UVA; HALS; and mineral fillers), the yellowness index change (ΔYI) of the copolyetherester composition after aging is dramatically decreased. Therefore, compared to prior art copolyetherester compositions, the copolyetherester compositions disclosed herein (i.e., the copolyetherester compositions containing the three-component UV stabilizing package), possess not only improved physical properties (e.g., nominal strain at break) but also less discoloration after aging. In addition, because they are substantially free of carbon black, the copolyetherester compositions disclosed herein are suitable for forming products of natural or light color.

In accordance, the copolyetherester composition disclosed herein may have a ΔYI of less than about 2.3, or less than about 2, or less than about 1.5 after 1500-hour aging. The ΔYI disclosed herein is determined in accordance to ASTM E313 and the 1500-hour aging is conducted in accordance to ISO4892-2 with the chamber temperature set at 38±3° C., black standard temperature at 65±3° C., relative humidity at 50±10%, and irradiation intensity at 0.51 w/m² (at wavelength of 340 nm).

The copolyetherester compositions disclosed herein may be formed into articles using methods known to those skilled in the art, such as, for example, injection molding, blow molding, extrusion, thermoforming, melt casting, rotational molding, and slush molding. The copolyetherester compositions may be overmolded onto articles made from different materials. The copolyetherester compositions may be extruded into films. The copolyetherester compositions may be formed into monofilaments. The copolyetherester compositions may also be extruded into insulating layers or jackets for wires and cables.

Articles comprising the copolyetheresters compositions of the invention may include, without limitation, air bag doors, automotive dashboard components, other molded automotive interior parts, tubing, furniture components (such as components of office furniture, indoor furniture, and outdoor furniture), footwear components, roof liners, outdoor apparels, water management system components, insulating layers and/or jackets for cables and wires.

### EXAMPLES

### Material

Copolyetherester: Hytrel®5556 copolyetherester elastomer obtained from DuPont;
UVA: Tinuvin™326 UV absorber, purchased from BASF, Germany;
HALS: Chimssorb®944 hindered amine light stabilizer, purchased from BASF, Germany; and
TiO₂: DuPont® Light Stabilizer 210 obtained from DuPont, which are titanium dioxide particles having a weight average particle diameter of about 130-140 nm and surface treated with alumina.

### Test Methods:

Nominal strain at break: Copolyetherester compositions were molded into dumbbell test bar specimens and the nominal strain at break thereof were determined in accordance with ISO527-2.
Yellowness Index (YI): Copolyetherester compositions were molded into 60×60×2 mm plaques and the YI thereof was determined in accordance with ASTM E313 using an X-rite 8200 spectrophotometer (purchased from X-rite Corporation, U.S.A.).
Aging: Aging tests were performed in accordance with ISO4892-2 using a Ci4000 weatherometer (purchased from Atlas Material Testing Solutions, U.S.A.). During the aging process, the chamber temperature was set at 38±3° C., black standard temperature at 65±3° C., relative humidity at 50±10%, and irradiation intensity at 0.51 w/m² (at wavelength of 340 nm). The aging process included alternate 102 minute dry cycles and 18 minute spray cycles.

### Test Results:

All components contained in each of the copolyetherester compositions in Examples E1 and Comparative Examples CE1-2 and the amounts present are listed in Table 1 below. The compositions used in E1 and CE1-2 were prepared as follows. A TiO₂ masterbatch comprising 35 wt. % TiO₂ and 65 wt. % Copolyetherester was prepared using a ZSK-30 twin-screw extruder (purchased from Coperion Werner & Pfleiderer GmbH & Co., Germany) with the extruder temperature set at 150-230° C., the extrusion speed at 300 rpm, and the throughput at 30 lb/hr. Appropriate amounts of Copolyetherester, TiO₂ masterbatch, UVA, and HALS were then dried, pre-mixed, and melt blended in a ZSK26 twin-screw extruder (purchased from Coperion Werner & Pfleiderer GmbH & Co., Germany) with the extruder temperature set at 220-235° C., the extrusion speed at 300 rpm, and the throughput at 20 kg/hr, to obtain the copolyetherester compositions.

Each of the copolyetherester compositions used in E1 and CE1-2 were molded into dumbbell test bar specimens and the nominal strain at break thereof were determined as described above and tabulated in Table 1. The test bar specimens were then aged for 100 hours, 200 hours, 500 hours, 1000 hours, or 1500 hours and the nominal strain at break thereof after aging were determined as described above and tabulated in Table 1. Thereafter, the “retention rate of nominal strain at break” of the compositions after aging were calculated and tabulated in Table 1.

In addition, each of the copolyetherester compositions used in E1 and CE1-2 was molded into a 60×60×2 mm plaque and the YI thereof was determined as described above and tabulated in Table 1. The plaques were then aged for 100 hours, 200 hours, 500 hours, 1000 hours, or 1500 hours and the YI thereof after aging were determined as described above and tabulated in Table 1. Thereafter, the “Yellowness Index Change (ΔYI)” of the compositions after aging was calculated and tabulated in Table 1.

The results demonstrate that when TiO₂ is added to copolyetherester compositions, in the presence of both UVA and HALS, not only is the retention of nominal strain at break (after aging) of the compositions is improved, the yellowness index change (ΔYI) (after aging) of the compositions is also largely reduced.

TABLE 1

| | CE1 | CE2 | E1 |
|---|---|---|---|
| Copolyetherester (wt %) | 94.4 | 94.4 | 94.4 |
| UVA (wt %) | 0.6 | 0 | 0.3 |
| HALS (wt %) | 0 | 0.6 | 0.3 |
| TiO₂ (wt %) | 5 | 5 | 5 |
| Retention rate of Nominal Strain at break | 97.92 | 96.16 | 103.08 |
| (post 100 hr aging) (%) | | | |
| Retention of Nominal Strain at break | 91.49 | 99.51 | 105.93 |
| (post 200 hr aging) (%) | | | |
| Retention rate of Nominal Strain at break | 90.97 | 98.07 | 104.27 |
| (post 300 hr aging) (%) | | | |
| Retention rate of Nominal Strain at break | 80.06 | 96.16 | 97.50 |
| (post 500 hr aging) (%) | | | |
| Retention rate of Nominal Strain at break | 72.43 | 88.93 | 104.88 |
| (post 1000 hr aging) (%) | | | |
| Retention rate of Nominal Strain at break | 63.20 | 88.16 | 108.85 |
| (post 1500 hr aging) (%) | | | |
| ΔYI (post 100 hr aging) | 2.43 | 2.14 | 0.30 |
| ΔYI (post 200 hr aging) | 4.61 | 1.91 | 0.52 |
| ΔYI (post 500 hr aging) | 11.30 | 2.98 | 1.19 |
| ΔYI (post 1000 hr aging) | 16.22 | 3.02 | 0.89 |
| ΔYI (post 1500 hr aging) | 16.27 | 2.32 | 1.24 |

What is claimed is:

1. A light stabilized copolyetherester composition that is substantially free of carbon black, wherein the copolyetherester composition comprises, based on the total weight of the copolyetherester composition,
(a) about 90-98.8 wt. % of at least one copolyetherester,
(b) about 0.1-2 wt. % of at least one organic UV absorber selected from the group consisting of benzotriazole based UV absorbers and benzophenone based UV absorber,
(c) about 0.1-2 wt. % of at least one hindered amine light stabilizer, and
(d) about 1-6 wt. % of at least one mineral filler comprising mineral particles selected from the group consisting of titanium dioxide particles, cerium oxide particles, zinc oxide particles, and mixtures of two or more thereof.

2. A light stabilized copolyetherester composition of claim 1, wherein, the at least one copolyetherester comprises a multiplicity of recurring long-chain ester units and recurring short-chain ester units joined head-to-tail through ester linkages, the long-chain ester units being represented by formula (I): 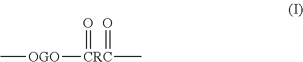
and the short-chain ester units being represented by formula (II): 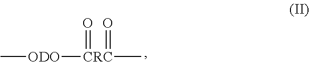
wherein,
G is a divalent radical remaining after the removal of terminal hydroxyl groups from a poly(alkylene oxide) glycol having a number average molecular weight of about 400-6000;
R is a divalent radical remaining after the removal of carboxyl groups from a dicarboxylic acid having a number average molecular weight of about 300 or lower; and
D is a divalent radical remaining after the removal of hydroxyl groups from a glycol having a molecular weight of about 250 or lower, and
wherein,
based on the total weight of the at least one copolyetherester, the recurring long-chain ester units and the recurring short-chain ester units are present in amounts of about 1-85 wt % and about 15-99 wt %, respectively.

3. A light stabilized copolyetherester composition of claim 1, wherein the mineral particles have a weight average particle diameter of about 10-200 nm.

4. A light stabilized copolyetherester composition of claim 1, wherein the mineral particles are titanium dioxide particles.

5. A light stabilized copolyetherester composition of claim 1, wherein the mineral particles are coated with organic coatings or inorganic coatings.

6. A light stabilized copolyetherester composition of claim 5, wherein the organic coatings comprise a material selected from the group consisting of carboxylic acids, polyols, alkanolamines, silicon compounds, and mixtures of two or more thereof.

7. A light stabilized copolyetherester composition of claim 5, wherein the inorganic coatings comprise a material selected from the group consisting of oxides and hydrous oxides of silicon, aluminum, zirconium, phosphorous, zinc, rare earth elements, and mixtures of two or more thereof.

8. A light stabilized copolyetherester composition of claim 7, wherein the inorganic coatings comprise alumina.

9. A light stabilized copolyetherester composition of claim 1, wherein the at least one mineral filler comprises titanium dioxide particles having a weight average particle diameter of about 10-200 nm.

10. A light stabilized copolyetherester composition of claim 9, wherein the titanium dioxide particles are coated with alumina.

11. A light stabilized copolyetherester composition of claim 1, wherein the at least one organic UV absorber is selected from the group consisting of benzotriazole based UV absorbers.

12. A light stabilized copolyetherester composition of claim 1, wherein, based on the total weight of the copolyetherester composition, the copolyetherester composition comprises about 90-98.8 wt. % of the at least one copolyetherester, about 0.1-2 wt. % of the at least one organic UV absorber, about 0.1-2 wt. % of the at least one hindered amine light stabilizer, and about 1-6 wt. % of the mineral filler.

13. A light stabilized copolyetherester composition of claim 1, wherein, based on the total weight of the copolyetherester composition, the copolyetherester composition comprises about 92-98.8 wt. % of the at least one copolyetherester, about 0.1-1 wt. % of the at least one organic UV absorber, about 0.1-1 wt. % of the at least one hindered amine light stabilizer, and about 1-6 wt. % of the mineral filler.

14. A light stabilized copolyetherester composition of claim 1, wherein, based on the total weight of the copolyetherester composition, the copolyetherester composition comprises about 92-98.6 wt. % of the at least one copolyetherester, about 0.1-0.6 wt. % of the at least one organic UV absorber, about 0.1-0.6 wt. % of the at least one hindered amine light stabilizer, and about 1-6 wt. % of the mineral filler.

15. A light stabilized copolyetherester composition of claim 1, wherein, based on the total weight of the copolyetherester composition, the copolyetherester composition comprises about 92-97.8 wt. % of the at least one copolyetherester, about 0.1-1 wt. % of the at least one organic UV absorber, about 0.1-1 wt. % of the at least one hindered amine light stabilizer, and about 2-6 wt. % of the mineral filler.

16. A light stabilized copolyetherester composition of claim 1, wherein, based on the total weight of the copolyetherester composition, the copolyetherester composition comprises about 92-95.8 wt. % of the at least one copolyetherester, about 0.1-1 wt. % of the at least one organic UV absorber, about 0.1-1 wt. % of the at least one hindered amine light stabilizer, and about 4-6 wt. % of the mineral filler.

17. A light stabilized copolyetherester composition of claim 1, wherein, based on the total weight of the copolyetherester composition, the copolyetherester composition comprises about 92.8-95.6 wt. % of the at least one copolyetherester, about 0.2-0.6 wt. % of the at least one organic UV absorber, about 0.2-0.6 wt. % of the at least one hindered amine light stabilizer, and about 4-6 wt. % of the mineral filler.

18. A light stabilized copolyetherester composition of claim 1, wherein, the copolyetherester composition has a yellowness index change (ΔYI) of less than about 2.3, or less than about 2, or less than about 1.5 after 1500-hour aging.

19. An article formed from the light stabilized copolyetherester composition recited in claim 1.

20. The article of claim 19, wherein the article is an insulating layer or jacket for wires and cables.
